(19) United States
(12) Patent Application Publication
(10) Pub. No.: US 2008/0041904 A1
(43) Pub. Date: Feb. 21, 2008

(54) LAWN TRACTOR MOUNTED CARGO CONTAINER

(75) Inventors: David E. Price, Afton, OK (US); Charlie L. Forbis, Quapaw, OK (US); Grady Fort, Mason, TX (US)

Correspondence Address: HOVEY WILLIAMS LLP, 10801 Mastin Blvd., Suite 1000, Overland Park, KS, 66210, US

(73) Assignee: BLITZ U.S.A., INC., Miami, OK (US)

(21) Appl. No.: 11/465,173

(22) Filed: Aug. 17, 2006

(51) Int. Cl. B60R 9/00

(52) U.S. Cl. 224/519

(57) ABSTRACT

A tractor-mounted utility container (20) is provided having a main body (24) and an alternate use panel (26) which can be positioned in an upright fashion to close the rear opening (74) of the body (24), or alternately in a horizontal orientation within the confines of the body (24). In either orientation, the panel (26) has a tool-holding section (84) which is capable of holding handled tools (134) for travel. The main body (24) and panel (26) have interengageable mounting structure (48, 76, 78, 54, 66, 92) for maintaining the panel (26) in the alternate positions thereof. The container (20) may be mounted on the draw plate (34) of a tractor (22) by means of an improved universal hitch assembly (32). The assembly (32) includes a slotted connection plate (110) which can be attached to the hitch plates (34) of different tractors (22) together with an upright connector (116) supported by the plate (110) and received within a socket (78) formed in the front wall (42) of main body (24).

### CROSS REFERENCE TO RELATED APPLICATION

This application is being filed contemporaneously with application for U.S. Design patent application Ser. No. 29/248,466, entitled LAWN TRACTOR MOUNTED CARGO CONTAINER, which is hereby incorporated by reference herein.

### BACKGROUND OF THE INVENTION

1. Field of the Invention

The present invention is broadly concerned with improved tractor-mounted containers of the type used by homeowners with small garden tractors, in order to hold gardening tools and supplies. More particularly, the invention is concerned with such containers having an alternately positionable panel which can be used to close the rear open end of the container or as a generally horizontal work shelf. The present invention is also broadly concerned with a universal hitch assembly permitting attachment of various tractor-mounted accessories, including a cargo container, to a variety of different tractors.

2. Description of the Prior Art

Lawn tractors are increasingly popular with homeowners having large yards or gardens. These tractors can include mowers or be used for other purposes, including the transport of supplies and the like to various work sites. It is common to provide such small tractors with a variety of accessories to assist the homeowner in yard or garden work. For example, cargo containers are commonly attached to the tractors in order to provide a convenient means of transporting tools and lawn and garden supplies.

It is important that such tractor-mounted containers have a high degree of versatility to meet the myriad needs of a homeowner. Thus, it has been suggested in the past to provide a tractor-mounted container having a rear tailgate which can be moved between a lowered closing position and an upper horizontal position. See, e.g., U.S. Pat. Nos. 5,064,338, 5,195,310, and Patent Application Publication No. 2004/0211803. Such containers may also have various expedients for holding lawn and garden tools during travel and to maintain an orderly work site. However, prior art tractor containers have limited versatility, meaning they are designed for use in only one or very limited configurations. Furthermore, prior art tractor containers often have designs that provide inadequate strength for supporting heavy loads.

Another drawback of typical tractor-mounted accessories is that they include hitch assemblies which are tractor type-specific, i.e, the hitch assemblies are usable only with certain types of tractors. This is a problem because the draw plates provided on tractors of various manufacturers are not standardized. Thus, a consumer may purchase a tractor accessory, but be unable to easily mount the accessory on a given tractor, owing to deficiencies in the hitch provided with the accessory. Although some prior art accessories might permit attachment to various tractors, they typically require undesirable alteration of the tractor (e.g., drilling of holes in the draw plate).

The following patents disclose a variety of tractor-mounted containers and like devices: 3,791,118, 4,532,756, 4,589,251, 4,596,347, 6,439,444, D326,173, D336,701, D463,456, and D476,341.

### SUMMARY OF THE INVENTION

The present invention overcomes the problems noted above and provides numerous advantages over the prior art.

According to a first aspect of the present invention, a container adapted for mounting to a tractor generally comprises a main container body and a panel. The main container body presents presenting a bottom wall, upstanding side and front walls, and an open rear section. The panel is configured to be alternately oriented in a tailgate position in which the panel is in upright closing relationship to the open rear section, and a shelf position in which the panel is in a generally horizontal orientation substantially within the confines of the main body. The main container body and panel have interengageable mounting structure for maintaining the panel in the alternate positions thereof. The panel has a tool-holding section operable to hold handled tools in an upright orientation when the panel is in either of its alternate positions.

In preferred forms, the alternate use panel has a main panel section and an obliquely oriented, tool-holding section, wherein the tool-holding section is apertured to receive the handles of tools. In this fashion the tool-holding section retains its utility regardless of the position of the panel relative to the main body.

In addition, the preferred container has a pair of auxiliary containers detachably secured to the main body sidewalls, in order to provide additional functionality. The auxiliary containers each have connection hooks, whereas the sidewalls of the main body have complemental open connection blocks; in this fashion the auxiliary containers are detachably secured to the main body by insertion of the hooks into the connection blocks.

Another aspect of the present invention concerns a universal accessory-supporting hitch assembly operable to be attached to any one of a variety tractors, each having a draw plate with an upright segment and a rearwardly-projecting connection segment provided with a connection aperture. The universal accessory-supporting hitch assembly includes a tractor accessory support configured to support a tractor accessory thereon, and an elongated connection plate configured to mount the tractor accessory support to the draw plate. The connection plate presents a forward upstanding lip and an elongated slot. The lip is configured to be placed in front of and in engagement with the upright segment of the draw plate, with the slot being in alignment with the connection aperture. The hitch assembly also includes a coupler adapted to extend through the slot and the aligned aperture in order to secure the connection plate to the draw plate.

Preferably, the tractor accessory support includes an upright connector received within a complemental socket of the accessory. Additional support may be provided by means of elongated cables which are secured to the tractor draw plate and the upright connector.

A third aspect of the present invention concerns a container adapted for mounting to a tractor, where in the container generally includes a main container body and a panel. The main container body presents a bottom wall, upstanding side and front walls, and an open rear section. The panel is configured to be alternately oriented in a tailgate position in which the panel is in upright closing relationship to the open rear section, and a shelf position in which the panel is in a generally horizontal orientation substantially within the confines of the main body. Each of the side walls and the panel cooperatively presenting opposed interengaging surfaces in each of the alternate positions of the panel, with the surface of each side wall facing outwardly and the surface of the panel facing inwardly, wherein outward deflection of the side walls is restricted by interengagement of the opposed surfaces when the panel is in the alternate positions thereof.

Other aspects and advantages of the present invention will be apparent from the following detailed description of the preferred embodiments and the accompanying drawing figures.

### BRIEF DESCRIPTION OF THE DRAWINGS

Preferred embodiments of the invention are described in detail below with reference to the attached drawing figures, wherein:

FIG. 1 is a fragmentary perspective view illustrating a preferred cargo container in accordance with the invention, mounted on a standard yard tractor, and showing the alternate use panel of the container in its container closure position;

FIG. 2 is an exploded perspective view of the cargo container of FIG. 1;

FIG. 3 is an exploded perspective view of certain components of the cargo container of FIG. 1, shown in a perspective angularly offset to that of FIG. 2;

FIG. 4 is a fragmentary perspective view illustrating the interengageable attachment components on the main body of the cargo container and the alternate use panel of the container, allowing the panel to serve as a tailgate or closure for the container;

FIG. 5 is a plan view of the cargo container of FIG. 1, with the alternate use panel in its tailgate position;

FIG. 6 is a vertical sectional view taken along line 6-6 of FIG. 5 and illustrating the hitch mounting of the cargo container;

FIG. 7 is a vertical sectional view taken along line 7-7 of FIG. 5 and depicting the attachment of the lateral auxiliary containers detachably secured to the cargo container;

FIG. 8 is a fragmentary vertical sectional view similar to that of FIG. 1, but showing the alternate use panel in its shelf position;

FIG. 9 is a plan view of the cargo container of FIG. 8, with the alternate use panel in its shelf position;

FIG. 10 is a vertical sectional view taken along line 10-10 of FIG. 9, illustrating the interconnection between the alternate use panel and the main body of the container, when the panel is in its shelf position; and

FIG. 11 is a vertical sectional view taken along line 11-11 of FIG. 10, and further illustrating the interconnection between the alternate use panel and the main body of the container.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

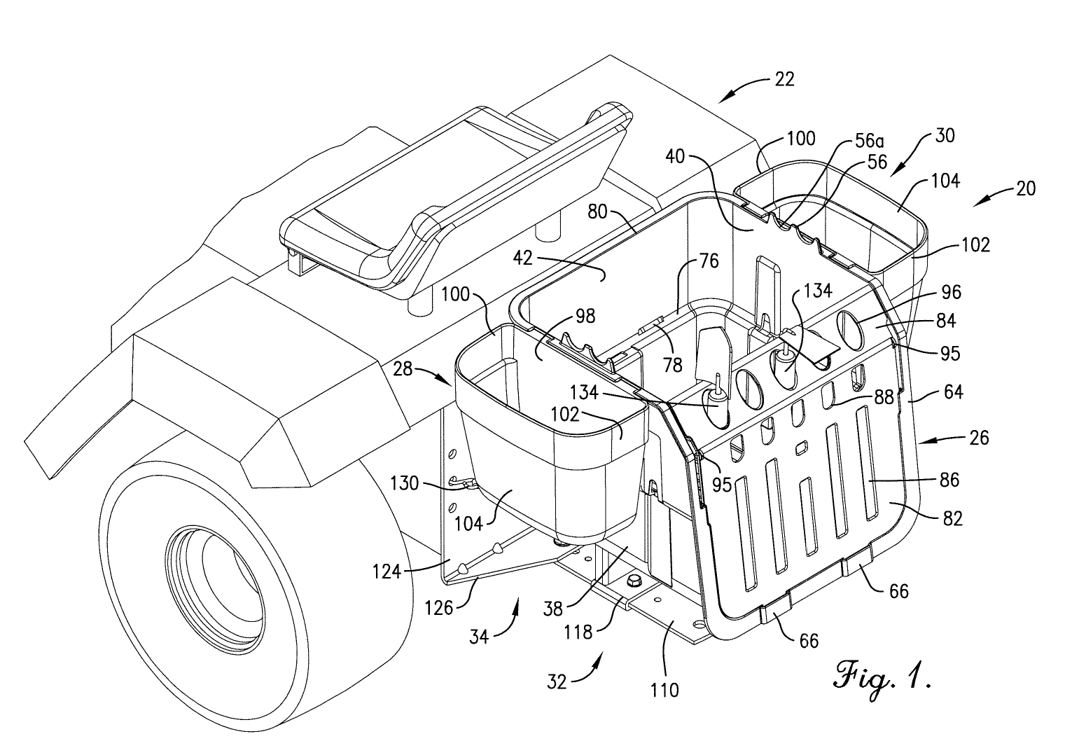

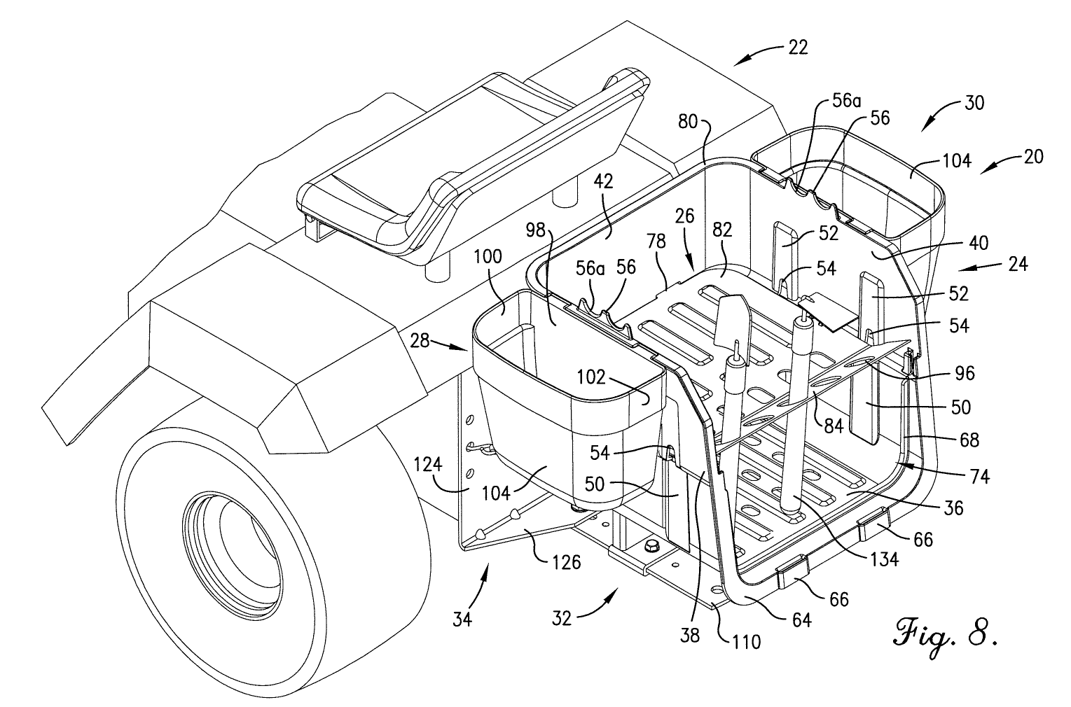

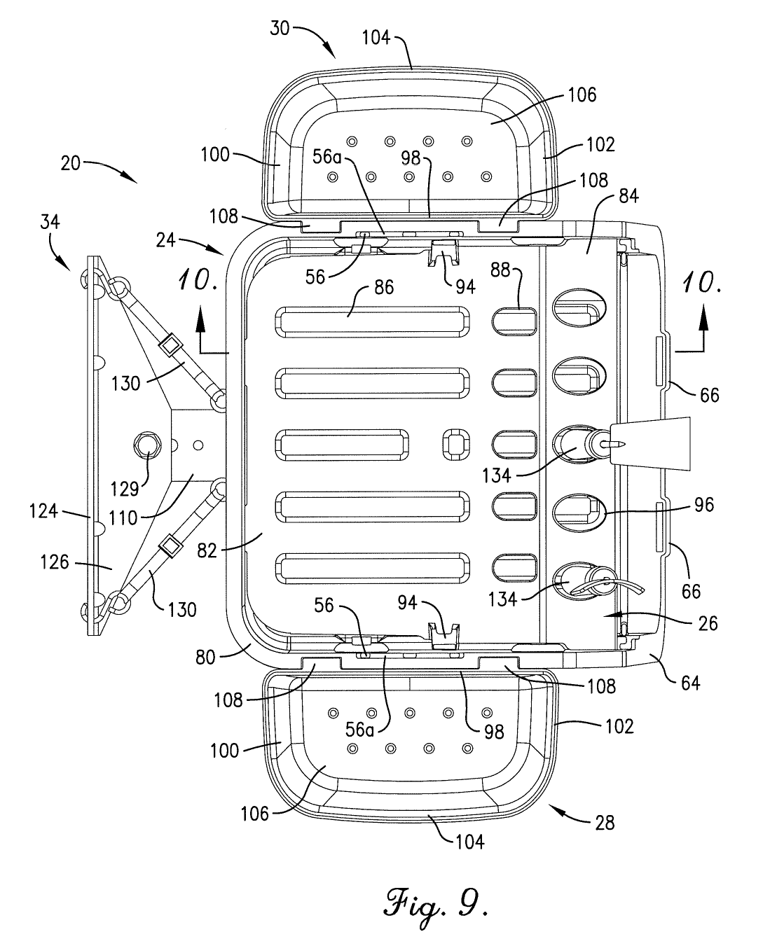

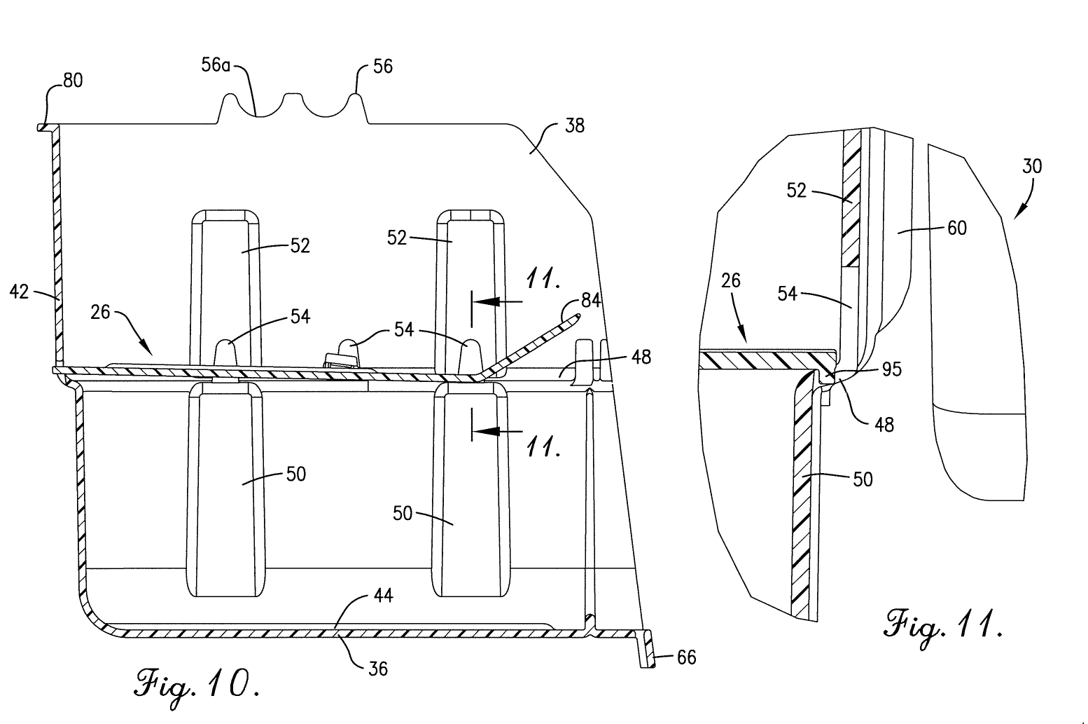

Turning now to the drawings, a tractor-mounted cargo container 20 is illustrated in FIG. 1, mounted to the rear of a standard tractor 22. Broadly speaking, the container 20 includes a main body 24, alternate use panel 26, a pair of side-mounted auxiliary containers 28 and 30, and a hitch assembly 32 designed to support the components 24-30 in a mounted position attached to the standard draw plate 34 of tractor 22. The container 20 is designed for ready attachment to a variety of different tractors, in order to provide a convenient place for hauling of yard equipment and/or supplies. A particular feature of the container 20 is the provision of panel 26 which can serve as a rear closure (or tailgate) for the body 24 (FIG. 1), or alternately as a generally horizontally disposed work shelf (FIG. 8); in either case, the panel 26 provides a tool-supporting function. Furthermore, the hitch assembly 32 permits the components 24-30 to be universally attached to virtually any tractor 22, as will subsequently be described.

In more detail, the main body 24 is preferably formed of molded synthetic resin material, although other suitable materials and fabrication techniques may be used. The main body 24 generally includes a bottom wall 36, a pair of opposed sidewalls 38 and 40, and front wall 42. The bottom wall 36 has a series of elongated, laterally spaced apart, upstanding stiffening ribs 44 and a series of drainage holes 46 between the ribs 44. The bottom wall 36 has rounded side margins which merge with the upstanding side walls 38, 40. The particular configuration of the main body 24 may be varied and still fall within the scope of the present invention; however, it is important that the main body 24 presents an open rear section as further defined below.

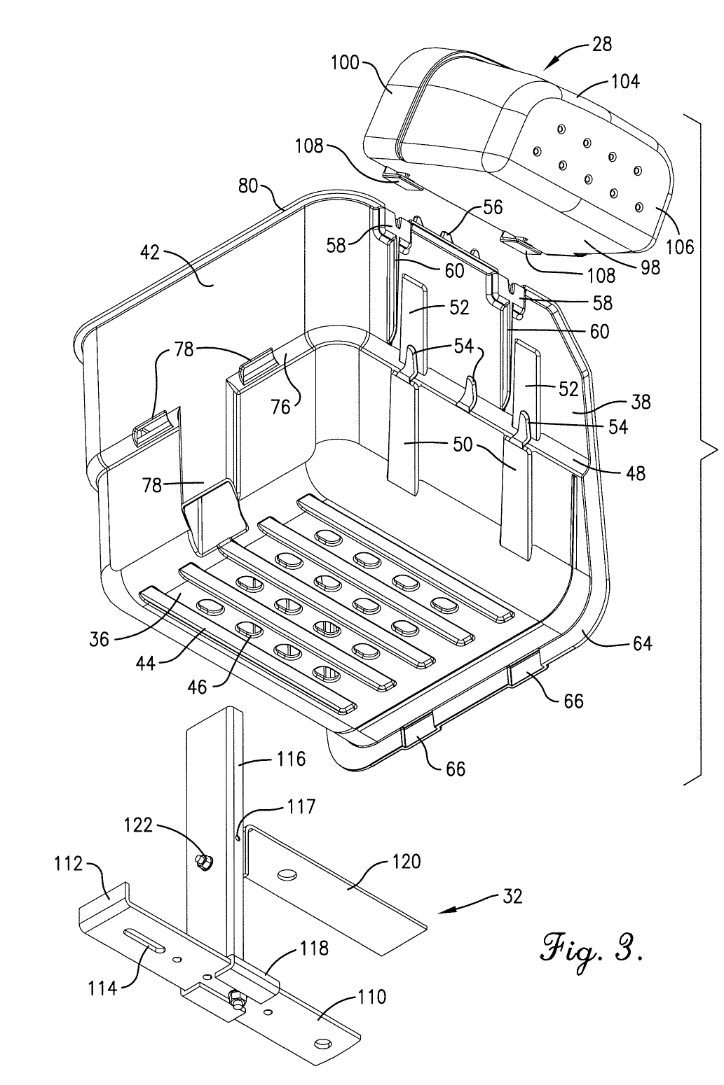

The sidewalls 38, 40 are preferably mirror opposites of each other, and each has an elongated, inwardly-extending ledge 48 as well as a pair of inwardly-extending, generally rectangular protrusions 50 extending upwardly from the bottom of the respective sidewalls to merge with ledge 48. Additionally, mated rectangular protrusions 52 extend upwardly from the ledge 48. As best seen in FIG. 3, each of the sidewalls has a total of three openings 54 formed at the ledge 48 and extending upwardly along the respective sidewall 38 or 40 therefrom. Two of the openings 54 are aligned with the mated protrusions 50, 52, whereas the other opening 54 is located intermediate the mated protrusions. The openings 54 have a triangular shape, although other suitable opening shapes and locations are within the ambit of the present invention. The upper margins of the sidewalls have a total of three upwardly-extending tooth-like elements 56, with arcuate regions 56a being defined between the elements 56. Along the exterior surfaces of the sidewalls 38, 40 are a pair of somewhat rectangular, outwardly-extending, hollow latch blocks 58. A single depending rib 60 preferably extends downwardly from each latch block 58 to add desires strength and rigidity to this connection location.

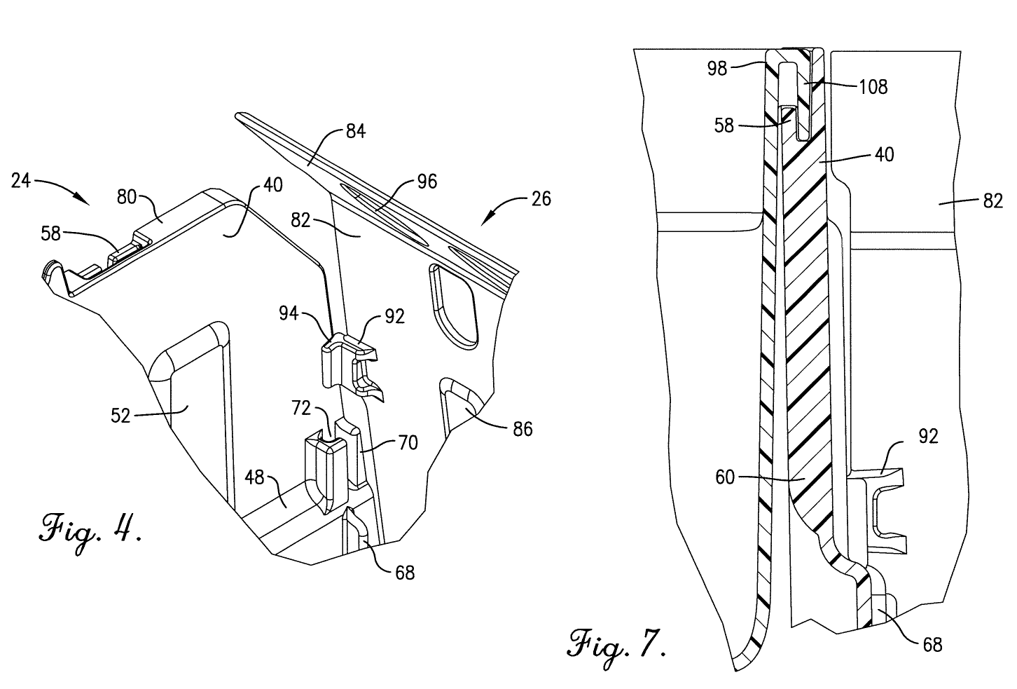

The front wall, bottom wall 36 and sidewalls 38, 40 are preferably equipped with mounting structure 62 designed to maintain the panel 26 in its alternate upright and horizontal orientations. The structure 62 includes a generally U-shaped rear margin 64 having a pair of laterally spaced apart, open-top, rectangular connection blocks 66 along the lower horizontal extent thereof, along with an inboard, generally U-shaped, inwardly-extending rib 68. As best seen in FIG. 4, each sidewall 38, 40 has an upright, two-piece clip 70 presenting a connection slot 72. The clips 70 are located directly above the uppermost ends of the ribs 68 adjacent the lateral ledge 48. It will thus be seen that the bottom wall 36 and sidewalls 38, 40 cooperatively define an open rear end 74. The rearmost openings 54 also function as part of the mounting structure 62 when the panel 26 is in the shelf position, as will be described.

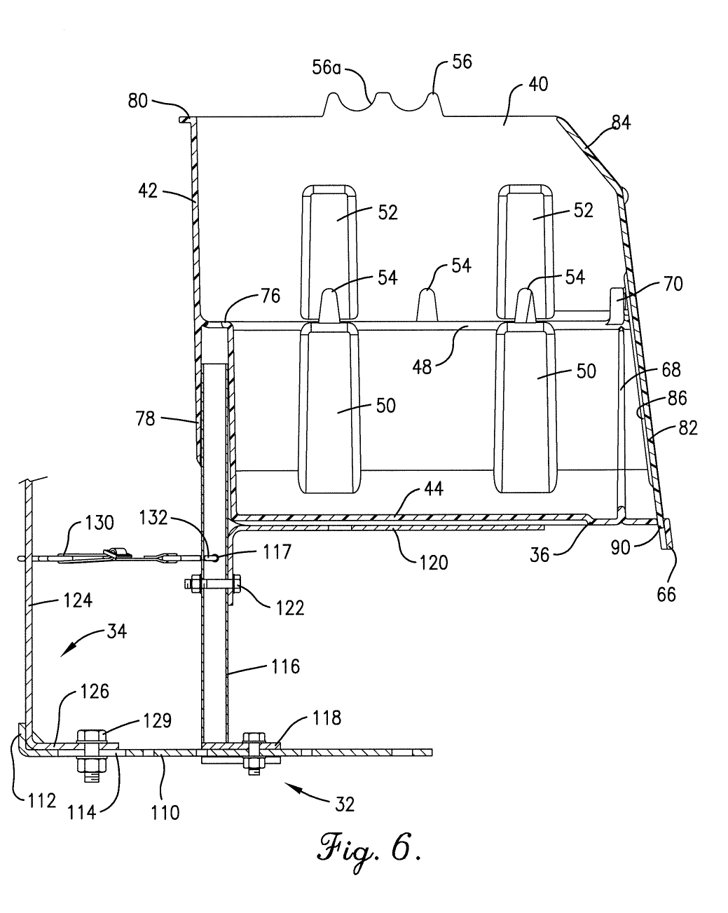

Front wall 42 merges with bottom wall 36 and sidewalls 38, 40 at rounded junctures, and also has a ledge 76 which extends between and forms a continuation of the sidewall ledges 48. As best seen in FIG. 3, the ledge 76 has a pair of horizontal connection slots 78 formed therein. As will be described, the connection slots 78 form part of the mounting structure 62, particularly when the panel 26 is the shelf position thereof. The exterior of front wall 42 has a depending, downwardly open socket 78 which extends downwardly from ledge 76 (see FIG. 6). The front wall 42 and sidewalls 38, 40 cooperatively present a continuous upper marginal lip 80 which merges with the rear margin 64 and is interrupted by the latch blocks 58.

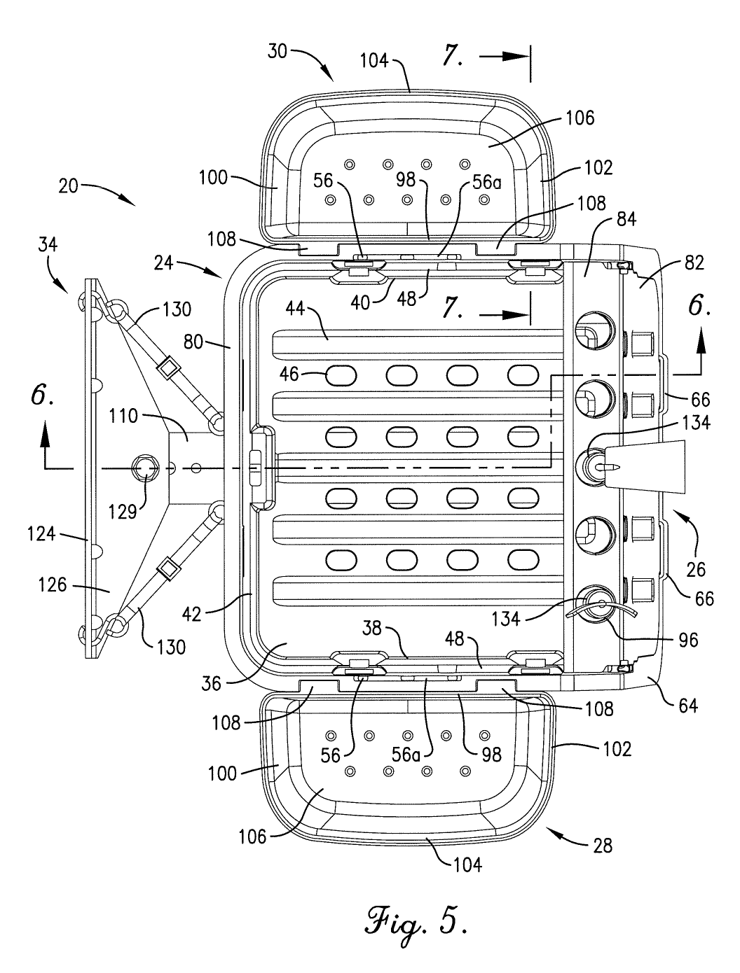

The alternate use panel 26 is of integrally molded, synthetic resin construction, although other suitable materials and fabrication techniques may be used. The panel 26 preferably has a generally rectangular main panel section 82 as well as an obliquely oriented tool-holding section 84. The panel section 82 is equipped with a plurality of inwardly-extending strengthening ribs 86 as well as a series of upper openings 88. The lower margin of the panel section 82 includes a pair of laterally spaced apart connection tongues 90. The inner face of the panel section 82 has a pair of marginal connecting lugs 92 with inwardly projecting segments 94 (FIG. 4), and a pair of oppositely-projecting marginal connection ears 95 are formed at the juncture between the panel section 82 and section 84. It is noted that the use of the terms upper and lower are for illustrative purposes only and assume the panel is in the tailgate position thereof (as depicted, e.g., in FIGS. 1, 2, and 4-6). The section 84 also has a number of tool handle-receiving openings 96 formed therein. It is also noted that the connection tongues 90, lugs 92 and ears 95 form part of the mounting structure for interconnecting the main body 24 and panel 26 in the alternate positions of the panel 26.

The main body 24 and panel 26 preferably present opposed interengaging surfaces in each of the alternate positions of the panel 26, wherein the surfaces are specifically configured to restrict bowing out of the side walls when the container 20 is filled with a load. More particularly, one of the surfaces faces outwardly and is defined in each side wall and another surface is defined in the panel to face inwardly in an opposed relationship to the respective one of the surfaces, wherein outward deflection of the side walls is restricted by interengagement of the opposed surfaces when the panel is in the alternate positions thereof. In the preferred embodiment, the opposed surfaces are defined by certain components of the mounting structure 62. When the panel is in the upright tailgate position, the two-piece clips 70 cooperate with the lugs 92 to present the opposed surfaces. As perhaps best shown in FIG. 4, each lug 94 is preferably L-shaped and complementally received in the respective slot 72, with the inside surface of the segment 94 and the outwardly-facing slot-defining surface of the clip 70 serving as the opposed surfaces. As shown in FIG. 11, when the panel 26 is in the horizontal shelf position, each ear 95 is received in the rearmost opening 54 of the corresponding side wall. The inside surface of each ear 95 and the protrusion-defining outer surface of the sidewall cooperatively define the opposed surfaces. It is noted that the ears 95 are preferably semicircular in shape to fit snugly within the corresponding opening 54. Those of ordinary skill in the art will appreciate, however, that the principles of the present invention are equally applicable to forming the opposed surfaces with other components of the container 20 (e.g., components other than the mounting structure). Furthermore, it is entirely within the ambit of the present invention to modify the mounting structure 62 so that the projecting components (lugs 92, ears 95, and tongues 90) and complemental openings (slots 72 of clips 70, openings 54, and openings 66 or 78) are alternatively dimensioned or shaped. Yet further, some or all of the projecting components could alternatively be provided on the main body 24 with the respective openings being provided on the panel 26.

The auxiliary containers 28 and 30 are preferably identical and are designed to be detachably secured to the sidewalls 38, 40 of the main container body 24. Again, these containers are integrally molded of synthetic resin material, although other suitable materials and fabrication techniques may be used. Each auxiliary container preferably has substantially planar inner walls 98, sidewalls 100, 102, outboard wall 104, and apertured bottom wall 106. Each of the inner walls 98 has a pair of spaced apart, downwardly-extending connection hooks 108. The principles of the present invention are equally applicable to alternatively dimensioned and configured auxiliary containers. Moreover, certain aspects of the present invention encompass only one removable auxiliary container or none at all.

The hitch assembly 32 is preferably formed of metal (although other suitable materials are within the ambit of the present invention) and has a lowermost connection plate 110 having a forward, upturned lip 112 and an elongated slot 114. An upstanding, generally rectangular tube 116 is secured to the plate 110 via coupler 118. The tube 116 has a pair of side marginal holes 117, and supports a rearwardly-projecting brace 120 connected via coupler 122. The connection plate 110 preferably includes a plurality of mounting holes spaced apart in a fore-and-aft direction so that the coupler 118 is adjustably positionable on the plate 110. With the container 20 being supported on the tractor 22 in a cantilevered fashion, such an arrangement permits the user to adjust the center of gravity for the container 20 (and the load carried thereon), which can provide numerous advantages during operation (e.g., impact traction for the tractor 22). Furthermore, the connection plate 110 is preferably provided with a rearmost secondary hitch opening spaced rearwardly from the mounting holes of the coupler 118. This opening permits additional components (e.g., a trailer) to be connected to the tractor 22 via the hitch assembly 32.

The tube and the brace 120 cooperatively form a tractor accessory support, which can be variously configured depending upon the accessory to be supported on the tractor thereby. In the illustrated embodiment, the support is particularly designed to support the components 24-30. However, the principles of the present invention are equally applicable to use of the hitch assembly 32 to support other types of components on the tractor 22.

The tractor draw plate 34 has an upstanding segment 124 as well as a rearwardly-projecting segment 126 having aperture 128 formed therein and adapted to receive a connecting bolt 129. The hitch assembly 32 is particularly designed for use with other tractor designs having alternatively configured draw plates. Furthermore, the hitch assembly 32 includes a pair of flexible cables 130 each having connection hooks 132 at opposite ends thereof. The illustrated cables are adjustable length straps that can be selectively tightened by the user. However, the principles of the present invention are equally applicable to alternative cable designs, such as elastic straps or so-called bungee cords.

In use, the main body 24 of container 20 is secured to tractor 22 by means of hitch assembly 32. In particular, the plate 110 is first placed beneath segment 126 of draw plate 34, with lip 112 engaging the forwardly facing surface of the lower margin of upright segment 124. The plate 110 is then secured by means of bolt 129, which extends through aperture 128 and slot 114. Each cable 130 is then secured in place by inserting one of the hooks 132 into an available opening in the draw plate 34 (typically there are many) and the other hook into the corresponding hole 117 in the connector tube 116. The cables 130 are preferably oriented to extend laterally in opposite directions to prevent side-to-side movement of the main body 24. The main body 24 is then (or has previously been) secured to tube 116 by inserting the latter into socket 78 forming a part of front wall 42. This is perhaps best illustrated in FIG. 6. The auxiliary containers 28, 30 are next secured to the sidewalls 38, 40 by passing the hooks 108 into the latch blocks 58 (FIG. 7). The containers 28, 30 are further supported by means of the depending ribs 60 beneath each block 58. The foregoing steps have been described in a preferred sequence, although the principles of the present invention are equally applicable to assembly the container 20 in a different manner (e.g., the auxiliary containers 28, 230 may first be supported on the main body 24, which has been preassembled on the brace 120, with the cables being connected between the connector tube 116 and draw plate 34 before the coupler 129 is secured between the connection plate 110 and plate 34).

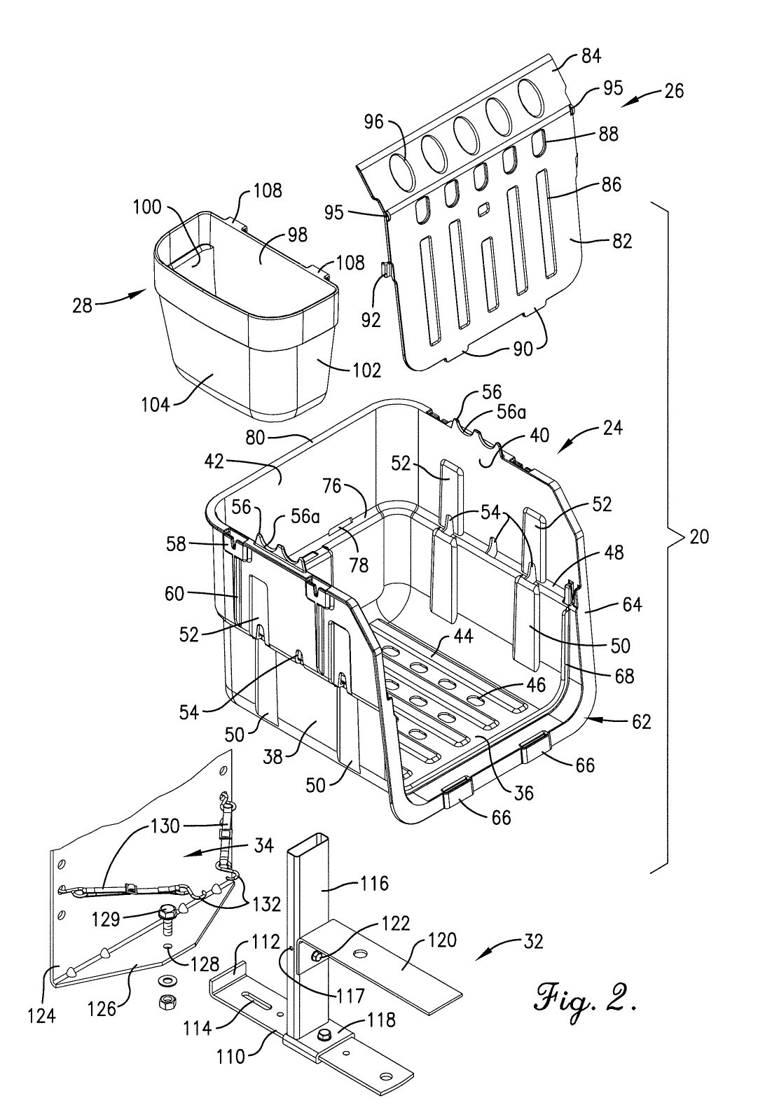

The alternate use panel 26 is affixed to the body 24 in either of its alternate positions. The panel 26 may be used to close the rear opening 74 of the body 24, or it may be oriented horizontally substantially within the confines of the body 24. The first alternative position is depicted in FIGS. 1 and 2, for example, and involves sliding the panel downwardly so that the segments 94 of the lugs 92 pass into the sidewall-mounted clips 70 (FIG. 4). This same movement causes the tongues 90 to be received within the open connection blocks 66. Finally, the side and lower margins of the panel 26 come into close conforming relationship with rear margin 64. As best illustrated in FIG. 1, when the panel 26 is in this rear closure position, the section 84 is oriented so that the openings 96 thereof can receive tool handles 134, in order to hold the tools in place during travel.

If it is desired to place the panel 26 in its horizontal shelf orientation (FIG. 8), the panel is simply placed atop ledges 48 and 76 of the sidewalls 38, 40 and front wall 42, followed by sliding the panel forwardly until the tongues 90 are received within the front wall slots 78. This same motion causes the projecting ears 95 to be received within the rearmost openings 54 of the sidewalls 38, 40 (FIG. 11). It will be observed that in this horizontal position, the section 84 extends obliquely upwardly, with the openings 96 oriented to receive the tool handles 134. Thus, the tools can be safely supported for travel regardless of the position of the panel 26. The apertures 96 in the tool-holding section 84 of the panel 26 are spaced above and located over the bottom wall 36 when the panel 26 is in the alternate positions thereof so that the bottom wall 36 serves as a lowermost support engaging the proximal end of the tool handle to there by support it within the container 24.

The container 24 and auxiliary containers 28, 30 can be loaded with tools and/or supplies, for easy transport to a work site. If desired, elongated tool handles can be placed in spanning relationship to the sidewalls 38, 40, by placing the handles within the arcuate regions 56a. These tools can then be secured for travel by the use of bungee cords or similar expedients attached to the forward openings 54.

The hitch assembly 32 is capable of mounting to essentially any standard tractor draw plate 34. That is, the draw plates of different manufacturers are not standardized, and therefore a hitch operable with one type of tractor will not normally be usable with other tractors. The present overcomes this difficulty, however, by provision of the slotted plate 110 which accommodates the bolt locations of virtually all different draw plates. The cables 130 enchance the secure connection between the container 20 and the tractor 22. Thus, a truly universal hitch assembly is provided.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby states their intent to rely on the Doctrine of Equivalents to determine and assess the reasonably fair scope of the present invention as pertains to any apparatus not materially departing from but outside the literal scope of the invention as set forth in the following claims.

What is claimed is:

1. A container adapted for mounting to a tractor, said container comprising:
a main container body presenting a bottom wall, upstanding side and front walls, and an open rear section; and
a panel configured to be alternately oriented in a tailgate position in which the panel is in upright closing relationship to the open rear section, and a shelf position in which the panel is in a generally horizontal orientation substantially within the confines of the main body,
said main container body and panel having interengageable mounting structure for maintaining the panel in the alternate positions thereof,
said panel having a tool-holding section operable to hold handled tools in an upright orientation when the panel is in either of said alternate positions.

2. The container as claimed in claim 1,
said panel including a main panel section and an obliquely oriented tool-holding section,
said tool-holding section presenting apertures to receive tool handles therein.

3. The container as claimed in claim 2,
each of said apertures being oval-shaped.

4. The container as claimed in claim 3,
said apertures being spaced above and located over the bottom wall when the panel is in the alternate positions thereof.

5. The container as claimed in claim 1,
said mounting structure including projecting components and complemental openings,
each of said projecting components being fixed to one of the panel and main body and a corresponding one of the openings being formed in the other of the panel and main body,
each of the projecting components being configured for receipt in the corresponding one of the openings.

6. The container as claimed in claim 5,
said mounting structure including opposed interengaging surfaces cooperatively presented by each side wall and the panel in each of the alternate positions of the panel,
said surfaces defining at least in part the projecting components and the complemental openings,
said opposed surface of each side wall facing outwardly and the corresponding opposed surface of the panel facing inwardly, wherein outward deflection of the side walls is restricted by interengagement of the opposed surfaces when the panel is in the alternate positions thereof.

7. The container as claimed in claim 1,
each of said side walls and said panel cooperatively presenting opposed interengaging surfaces in each of the alternate positions of the panel, with the surface of each side wall facing outwardly and the surface of the panel facing inwardly, wherein outward deflection of the side walls is restricted by interengagement of the opposed surfaces when the panel is in the alternate positions thereof.

8. The container as claimed in claim 7,
said opposed surfaces forming at least in part the mounting structure.

9. The container as claimed in claim 1; and
a pair of auxiliary containers detachably secured to the side walls of the main body.

10. The container as claimed in claim 9,
said side walls of the main body having open connection blocks,
each of said auxiliary containers having a connection hook removably received within the connection blocks.

11. The container as claimed in claim 1,
said container including a hitch assembly for supporting the main body on a tractor,
said hitch assembly including a main body support carrying the main body thereon,
said hitch assembly further including an elongated connection plate configured to mount the main body support to the tractor,
said connection plate presenting a forward upstanding lip and an elongated slot,
said hitch assembly further including a coupler adapted to extend through the slot and secure the connection plate to the tractor.

12. The container as claimed in claim 11,
said main body support including a connector secured to the connection plate to extend upwardly therefrom,
said main body presenting a socket receiving at least a portion of the connector therein.

13. The container as claimed in claim 12,
said main body support including a rearwardly-extending brace supported by the connector above the connection plate,
said brace underlying and engaging the bottom wall of the main body to provide underlying support thereto.

14. A universal accessory-supporting hitch assembly operable to be attached to any one of a variety tractors, each having a draw plate with an upright segment and a rearwardly-projecting connection segment provided with a connection aperture, said universal accessory-supporting hitch assembly comprising:
a tractor accessory support configured to support a tractor accessory thereon;
an elongated connection plate configured to mount the tractor accessory support to the draw plate,
said connection plate presenting a forward upstanding lip and an elongated slot,
said lip configured to be placed in front of and in engagement with the upright segment of the draw plate, with said slot being in alignment with the connection aperture; and
a coupler adapted to extend through the slot and the aligned aperture in order to secure the connection plate to the draw plate.

15. The universal accessory-supporting hitch assembly as claimed in claim 14; and
a connection strap connectable between the tractor accessory support and the draw plate.

16. The universal accessory-supporting hitch assembly as claimed in claim 15,
said connection strap being selectively adjustable in length.

17. The universal accessory-supporting hitch assembly as claimed in claim 14,
said connection strap including hooks at opposite ends thereof for removable connection to the tractor accessory support and draw plate.

18. The universal accessory-supporting hitch assembly as claimed in claim 14,
said tractor accessory support being adjustably mounted to the connection plate.

19. The universal accessory-supporting hitch assembly as claimed in claim 18,
said connection plate presenting a portion extending rearwardly from the slot and presenting a plurality of mounting holes in the portion, wherein the mounting holes are spaced apart in a fore-and-aft direction,
said tractor accessory support presenting a coupling opening which is selectively aligned with one of the mounting holes to position the tractor accessory support relative to the connection plate; and
a connection pin removably received within the coupling opening and aligned one of the mounting holes to releasably secure the tractor accessory support to the connection plate.

20. The universal accessory-supporting hitch assembly as claimed in claim 19,
said tractor accessory support including a tubular section slidably received on the connection plate, with the coupling opening being defined in the tubular section.

21. The universal accessory-supporting hitch assembly as claimed in claim 19,
said connection plate presenting a rearmost hitch opening spaced rearwardly from the mounting holes and configured for connection with a secondary component hitch.

22. The universal accessory-supporting hitch assembly as claimed in claim 14,
said tractor accessory support including a connector secured to the connection plate to extend upwardly therefrom,
said tractor accessory support further including a rearwardly-extending brace supported by the connector above the connection plate,
said brace being configured to underlie and engage the tractor accessory and thereby provide underlying support thereto.

23. The universal accessory-supporting hitch assembly as claimed in claim 22,
said brace presenting a generally flat upper surface.

24. The universal accessory-supporting hitch assembly as claimed in claim 23,
said connector projecting upwardly beyond the brace.

25. A container adapted for mounting to a tractor, said container comprising:
a main container body presenting a bottom wall, upstanding side and front walls, and an open rear section; and
a panel configured to be alternately oriented in a tailgate position in which the panel is in upright closing relationship to the open rear section, and a shelf position in which the panel is in a generally horizontal orientation substantially within the confines of the main body,
each of said side walls and said panel cooperatively presenting opposed interengaging surfaces in each of the alternate positions of the panel, with the surface of each side wall facing outwardly and the surface of the panel facing inwardly, wherein outward deflection of the side walls is restricted by interengagement of the opposed surfaces when the panel is in the alternate positions thereof.

26. The container as claimed in claim 25,
said opposed surfaces being substantially vertical.

27. The container as claimed in claim 26,
at least some of said corresponding opposed surfaces being spaced above the bottom wall.

28. The container as claimed in claim 25,
said main container body and panel having interengageable mounting structure for maintaining the panel in the alternate positions thereof,
said mounting structure including projecting components and complemental openings,
each of said projecting components being fixed to one of the panel and main body and a corresponding one of the openings being formed in the other of the panel and main body,
each of the projecting components being configured for receipt in the corresponding one of the openings.

29. The container as claimed in claim 28,
said opposed surfaces defining at least in part the projecting components and the complemental openings.

30. The container as claimed in claim 29,
said projecting components including a L-shaped lug that presents an inwardly projecting segment,
said mounting structure including a two-piece clip that defines a respective one of the complemental openings for the L-Shaped lug, wherein the respective one of the complemental openings is L-Shaped.

31. The container as claimed in claim 29,
said projecting components including a semicircular-shaped ear receivable within a corresponding one of the complemental openings.

32. The container as claimed in claim 28,
said projecting components including a pair of spaced apart connection tongues defined by the panel,
said complemental openings including two pairs of tongue-receiving holes, one of which receives the connection tongues when the panel is in the shelf position and the other of which receives the connection tongues when the panel is in the tailgate position.

33. The container as claimed in claim 25; and
a pair of auxiliary containers detachably secured to the side walls of the main body.

34. The container as claimed in claim 33,
said side walls of the main body having open connection blocks,
each of said auxiliary containers having a connection hook removably received within the connection blocks.

35. The container as claimed in claim 25,
said container including a hitch assembly for supporting the main body on a tractor,
said hitch assembly including a main body support carrying the main body thereon,
said hitch assembly further including an elongated connection plate configured to mount the main body support to the tractor,
said connection plate presenting a forward upstanding lip and an elongated slot,
said hitch assembly further including a coupler adapted to extend through the slot and secure the connection plate to the tractor.

36. The container as claimed in claim 35,
said main body support including a connector secured to the connection plate to extend upwardly therefrom,
said main body presenting a socket receiving at least a portion of the connector therein.

37. The container as claimed in claim 36,
said main body support including a rearwardly-extending brace supported by the connector above the connection plate,
said brace underlying and engaging the bottom wall of the main body to provide underlying support thereto.
